(19) United States
(12) Patent Application Publication
(10) Pub. No.: US 2011/0249178 A1
(43) Pub. Date: Oct. 13, 2011

(54) LIQUID CRYSTAL DISPLAY DEVICE

(75) Inventors: Mitsuyasu ASANO, Tokyo (JP); Hideo Morita, Kanagawa (JP); Tomohiro Nishi, Tokyo (JP)

(73) Assignee: Sony Corporation, Tokyo (JP)

(21) Appl. No.: 13/074,617

(22) Filed: Mar. 29, 2011

(30) Foreign Application Priority Data
Apr. 9, 2010 (JP) 2010-090454

(51) Int. Cl. H04N 7/01

(52) U.S. Cl. 348/441; 348/E07.003

(57) ABSTRACT

A liquid crystal display device including: a light source section including emission subsections; a LCD panel; and a display control section having a partitioning-drive processing section which generates an emission-pattern signal and a partitioning-drive image signal based on the input image signal. The display control section performs light-emission drive on each emission subsection based on the emission-pattern signal, and performs display-drive on the LCD panel based on the partitioning-drive image signal. The partitioning-drive processing section generates a primary emission-pattern signal corresponding to a primary pattern formed from lighting emission subsections based on the input image signal, performs a first frame-rate-increasing conversion on the primary emission-pattern signal to create the emission-pattern signal, performs a second frame-rate-increasing conversion on the input image signal by frame interpolation method with motion compensation, and generates the partitioning-drive image signal, based on the emission-pattern signal and the resultant of the second frame-rate-increasing conversion.

### BACKGROUND OF THE INVENTION

1. Field of the Invention

The present invention relates to a liquid crystal display device provided with a light source section, which includes a plurality of emission subsections.

2. Description of the Related Art

An active-matrix liquid crystal display (LCD) device has been recently popular for use as the display of a slim television and that of a mobile terminal device. In such an active-matrix liquid crystal display device, each pixel is provided with a TFT (Thin Film Transistor), and the pixels are generally driven from the upper to lower portion of the screen. Such pixel driving is performed by line-sequential writing of a video signal with respect to an auxiliary capacity element and a liquid crystal element in each of the pixels.

In the liquid crystal display device, a backlight includes a light source that is popularly a CCFL (Cold Cathode Fluorescent Lamp), and recently an LED (Light Emitting Diode) backlight is coming along.

For the liquid crystal display device using an LED backlight as such, a technique has been previously proposed to divide a light source section into a plurality of emission subsections, each of which individually performs a light emission operation, i.e., performs a partitioning-light-emission operation (for example, refer to Japanese Unexamined Patent Application NO. 2001-142409). During such a partitioning-light-emission operation, a emission-pattern signal and a partitioning-drive video signal are generated based on an input video signal. The emission-pattern signal shows a pattern of light emission on the basis of each of the emission subsections in the backlight.

### SUMMARY OF THE INVENTION

For the liquid crystal display device, a technique has been recently proposed to perform video display after a high frame rate conversion process utilizing frame interpolation with motion compensation, i.e., motion compensated frame interpolation. This technique is proposed with the aim of reducing, for example, the appearance of afterimages during display of moving images (for example, refer to Japanese Unexamined Patent Application NO. 2003-189257). With this technique, the high frame rate conversion process is performed by generating by interpolation a picture video between each two frames (original frames) next to each other, i.e., by generating an interpolation frame, utilizing motion vectors, for example.

Accordingly, the high frame rate conversion process may be performed to video signals as such at the same time with the video display with the partitioning-light-emission operation as described above. However, if such a previous partitioning-light-emission operation is performed with no change for the video display with the high frame rate conversion process, problems may arise as below, for example.

In other words, first of all, a video signal as a result of the high frame conversion process has a frame rate higher than that of an original video signal. This thus causes an increase of processing load for processing later on using the video signal after the high frame rate conversion process as such. Therefore, such a processing load becomes too much depending on when the high frame rate conversion process is performed. This results in a size increase of circuit or others, and eventually results in a cost increase.

Another problem is that the interpolation frame to be generated by the high frame rate conversion process may in some cases suffer from image quality degradation. This image quality degradation is due to the misalignment caused between the emission-pattern signal and the partitioning-drive video signal, which are generated differently by the high frame rate conversion process. To be specific, first of all, for generating the partitioning-drive video signal, the high frame rate conversion process to be performed is with the motion compensated frame interpolation for the aim of increasing the image quality as described above. On the other hand, for generating the emission-pattern signal, the high frame rate conversion process is executed by a frame interpolation method in which an original image frame is inserted between the very image frame and a subsequent image frame of the primary emission-pattern signal considering the performance expected thereto. Accordingly, in some cases, the degradation of the image quality is caused due to the misalignment in interpolation frames with the emission-pattern signal and the partitioning-drive video signal generated differently as such.

In consideration thereof, for performing video display during the high frame rate conversion process using a light source of the partitioning-light-emission operation, a new technique is in need for improving the display image quality at the same time with a reduction of cost.

It is thus desirable to provide a liquid crystal display device that can improve the display image quality with a reduction of cost during video display using a light source section of a partitioning-light-emission operation.

A liquid crystal display device in an aspect of the invention is provided with a light source section including a plurality of emission subsections which are controlled separately from one another, a liquid crystal display panel performing image-display through modulating, based on an input image signal, light coming from each of the emission subsections in the light source section, and a display control section having a partitioning-drive processing section which generates an emission-pattern signal and a partitioning-drive image signal based on the input image signal, the emission-pattern signal representing a two-dimensional pattern formed from lighting emission subsections in the light source section, the display control section performing light-emission drive on each of the emission subsections in the light source section based on the emission-pattern signal, and performing display-drive on the liquid crystal display panel based on the partitioning-drive image signal. The partitioning-drive processing section performs processes of generating, based on the input image signal, a primary emission-pattern signal corresponding to a primary pattern formed from the lighting emission subsections, executing a first frame-rate-increasing conversion on the primary emission-pattern signal, thereby to create the emission-pattern signal, executing a second frame-rate-increasing conversion on the input image signal by a method of frame interpolation with motion compensation; and generating the partitioning-drive image signal, based on both the created emission-pattern signal and the resultant image signal of the second frame-rate-increasing conversion.

With the liquid crystal display device in the aspect of the invention, an input video signal is used as a basis to generate a emission-pattern signal, and a partitioning-drive video signal. The emission-pattern signal is the one indicating a pattern of light emission on the basis of each of the emission subsections in the light source section. Using the emission-pattern signal generated as such, the emission subsections in the light source section are driven for light emission, and using the partitioning-drive video signal, the liquid crystal display panel is driven for display. During such driving, a primary emission-pattern signal is generated based on the input video signal, and then a first frame-rate-increasing conversion is performed on this primary emission-pattern signal, thereby generating the emission-pattern signal. Compared with a case of generating a emission-pattern signal in a reverse order, i.e., generating a emission-pattern signal based on a signal as a result of a high frame rate conversion process performed to the input video signal, the partitioning-drive processing section can be reduced in size in its entirety. Moreover, the partitioning-drive video signal is generated based on the emission-pattern signal and the resulting input video signal after a second frame-rate-increasing conversion with motion compensated frame interpolation performed to the input video signal. This accordingly reduces the appearance of afterimages during display of moving images with motion compensated frame interpolation. Furthermore, the partitioning-drive video signal is generated based on the signal as a result of the first frame-rate-increasing conversion, i.e., the emission-pattern signal, and the input video signal as a result of the second frame-rate-increasing conversion. This accordingly reduces or prevents the image quality degradation that is caused by the misalignment between the interpolation frames with the emission-pattern signal and the partitioning-drive video signal.

According to the liquid crystal display device in the aspect of the invention, after a emission-pattern signal is generated based on an input video signal, a emission-pattern signal is generated by a first frame-rate-increasing conversion performed to the primary emission-pattern signal. A partitioning-drive video signal is then generated based on the emission-pattern signal and the resulting input video signal after a second frame-rate-increasing conversion with motion compensated frame interpolation performed to the input video signal. This accordingly reduces the size of the partitioning-drive processing section in its entirety, reduces the appearance of afterimages during display of moving images, and reduces or prevents the image quality degradation to be caused in interpolation frames. As such, for video display using a light source section in charge of a partitioning-light-emission operation, the display image quality can be favorably improved with a reduction of cost.

### BRIEF DESCRIPTION OF THE DRAWINGS

FIG. 1 is a block diagram showing the entire configuration of a liquid crystal display device in an embodiment of the invention;

FIG. 2 is a circuit diagram of a pixel of FIG. 1, showing an exemplary detailed configuration thereof;

FIG. 3 is a schematic exploded perspective view of an exemplary emission sub-region and that of an exemplary irradiation sub-region both in the liquid crystal display device of FIG. 1;

FIG. 4 is a block diagram showing the detailed configuration of a partitioning-drive processing section of FIG. 1;

FIG. 5 is a schematic diagram for illustrating a high frame rate conversion process in which an original frame is inserted in a frame rate conversion section of FIG. 4;

FIG. 6 is a schematic diagram for illustrating a high frame rate conversion process with motion compensated frame interpolation in the frame rate conversion section of FIG. 4;

FIG. 7 is a schematic diagram showing the outline of a partitioning-light-emission operation of a backlight in the liquid crystal display device of FIG. 1;

FIG. 8 is a block diagram showing the configuration of a partitioning-drive processing section in a liquid crystal display device in a comparison example 1;

FIG. 9 is a block diagram showing the configuration of a partitioning-drive processing section in a liquid crystal display device in a comparison example 2;

FIG. 10 is a schematic diagram showing exemplary video display with a partitioning-light-emission operation in the comparison example 2;

FIGS. 11A and 11B are each a schematic diagram for illustrating problems to be caused during the video display with the partitioning-light-emission operation in the comparison example 2;

FIG. 12 is a schematic diagram showing exemplary video display with the partitioning-light-emission operation in the embodiment;

FIG. 13 is a block diagram showing the configuration of a partitioning-drive processing section in a modified example 1 of the invention;

FIG. 14 is a block diagram showing the configuration of a partitioning-drive processing section in a modified example 2 of the invention; and

FIGS. 15A to 15C are each a schematic diagram showing a partitioning-light-emission operation of a backlight in other modified example of the invention.

### DETAILED DESCRIPTION OF THE PREFERRED EMBODIMENT

In the below, an embodiment of the invention is described in detail by referring to the accompanying drawings. The description will be given in the following order.

1. Embodiment (exemplary video display with a partitioning-light-emission operation during a high frame rate conversion process to video signals)

2. Modified Examples

Modified Examples 1 and 2 (other exemplary arrangements of a frame rate conversion section in a partitioning-drive processing section)

Other Modified Examples (an exemplary edge-lit backlight, and others)

### Embodiment

### Entire Configuration of Liquid Crystal Display Device 1

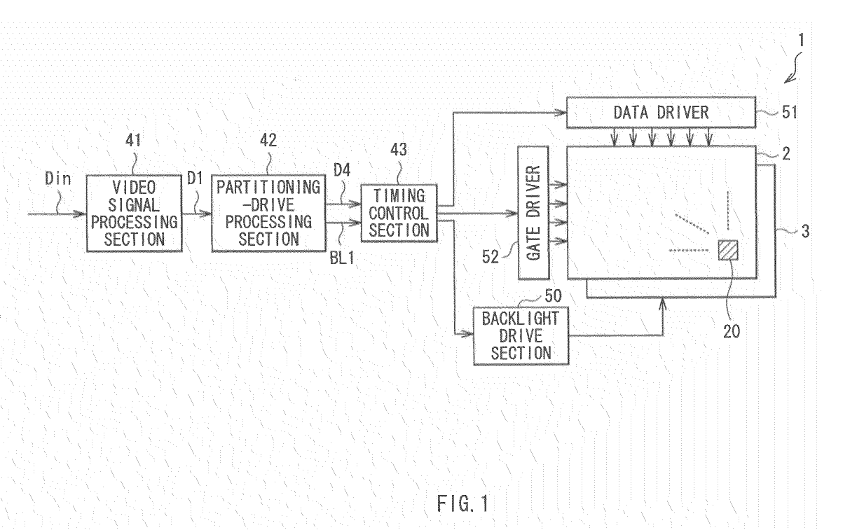

FIG. 1 is a block diagram showing the entire configuration of a liquid crystal display device in an embodiment of the invention, i.e., a liquid crystal display device 1.

The liquid crystal display device 1 is for performing video display based on an input video signal Din coming from the outside. This liquid crystal display device 1 is configured to include a liquid crystal display panel 2, a backlight 3 (a light source section), a video signal processing section 41, a partitioning-drive processing section 42, a timing control section 43, a backlight drive section 50, a data driver 51, and a gate driver 52. Among these, the components, i.e., the video signal processing section 41, the partitioning-drive processing section 42, the timing control section 43, the backlight drive section 50, the data driver 51, and the gate driver 52, are a specific example of a “display control section” of the invention.

The liquid crystal display panel 2 is for modulating a light coming from the backlight 3 (that will be described later) based on the input video signal Din, thereby performing video display based on this input video signal Din. This liquid crystal display panel 2 includes a plurality of pixels 20, which are arranged in a matrix in its entirety.

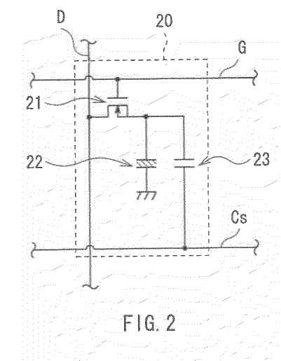

FIG. 2 is a diagram showing an exemplary circuit configuration of a pixel circuit in each of the pixels 20. The pixels 20 each include a liquid crystal element 22, a TFT element 21, and an auxiliary capacity element 23. The pixels 20 are each connected with a gate line G, a data line D, and an auxiliary capacity line Cs. The gate lines G are for line-sequentially selecting any of the pixels for driving, and the data lines D are for a supply of video voltage to the pixel(s) selected for driving. Herein, the video voltage is the one provided by the data driver 51 that will be described later.

The liquid crystal element 22 is for performing a display operation in accordance with a video voltage provided at an end thereof over the data line D via the TFT element 21. This liquid crystal element 22 includes a liquid crystal layer (not shown) sandwiched by a pair of electrodes (not shown). This liquid crystal layer is a VA (Vertical Alignment) or TN (Twisted Nematic) liquid crystal layer, for example. One (end) of the electrodes in the liquid crystal element 22 is connected to a drain of the TFT element 21 and to an end of the auxiliary capacity element 23, and the remaining (end) of the electrodes is grounded. The auxiliary capacity element 23 is a capacity element for use to stabilize the accumulated charge in the liquid crystal element 22. As to this auxiliary capacity element 23, an end thereof is connected to an end of the liquid crystal element 22 and to the drain of the TFT element 21, and the remaining end thereof is connected to the auxiliary capacity line Cs. The TFT element 21 is a switching element for a supply of video voltage to an end of the liquid crystal element 22 and to that of the auxiliary capacity element 23. This video voltage is the one based on a video signal D1, and the TFT element 21 is a MOS-FET (Metal Oxide Semiconductor-Field Effect Transistor). As to this TFT element 21, a gate thereof is connected to the gate line G, and a source thereof is to the data line D. The drain of the TFT element 21 is connected to an end of the liquid crystal element 22, and to that of the auxiliary capacity element 23.

The backlight 3 is a light source section that exposes a light to the liquid crystal display panel 2, and is configured by light emission elements of CCFL, LED, or others. As will be described later, the backlight 3 is to be driven for light emission in accordance with the details (video pattern) of the input video signal Din.

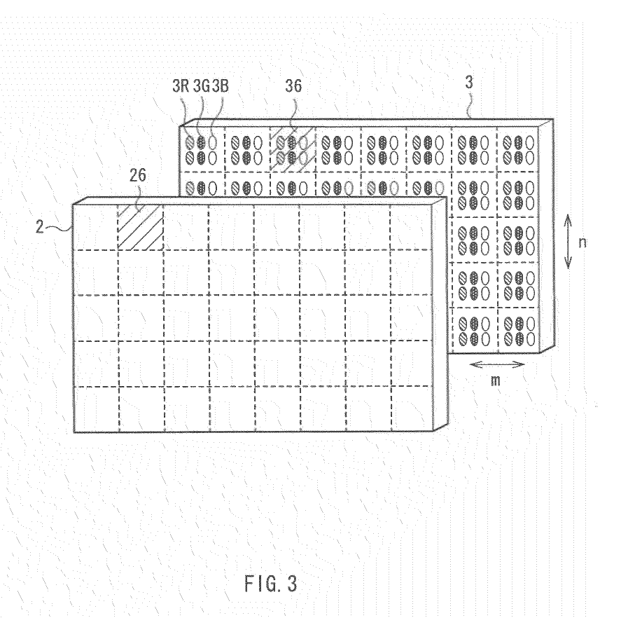

As exemplarily shown in FIG. 3, this backlight 3 is also provided with a plurality of emission sub-regions 36 (emission subsections), each of which are configured to be individually controllable. In other words, this backlight 3 is a partitioning-drive backlight. To be specific, each of the emission sub-regions 36 is configured by arranging a plurality of light sources two-dimensionally. As such, the light emission region of the backlight 3 is divided into, in the in-plane direction, n (vertical)×m (horizontal)=K (where n and m are each an integer of 2 or larger). Herein, this division number is set such that the resolution is to be lower than that of the pixels 20 in the liquid crystal display panel 2 described above. Moreover, as shown in FIG. 3, the liquid crystal display panel 2 is formed with a plurality of irradiation sub-regions 26 as many as the emission sub-regions 36.

The backlight 3 is controllable for light emission on the basis of each of the emission sub-regions 36 in accordance with the details (video pattern) of the input video signal Din. The light source in the backlight 3 is a combination of LEDs emitting lights of various colors, including a red LED 3R, a green LED 3G, and a blue LED 3B. The red LED 3R emits lights of red, the green 3G emits lights of green, and the blue LED 3B emits light of blue. Herein, the LEDs for use as the light source as such are surely not restricted by type thereto, and a white LED emitting lights of white is also a possibility. Herein, the emission sub-regions 36 are each provided at least with such a light source.

The video signal processing section 41 is for generating a video signal D1 by performing predetermined image processing to the input video signal Din, which includes a pixel signal of each of the pixels 20. The predetermined image processing includes processing of sharpness, gamma correction, and others, for the aim of increasing the image quality, for example.

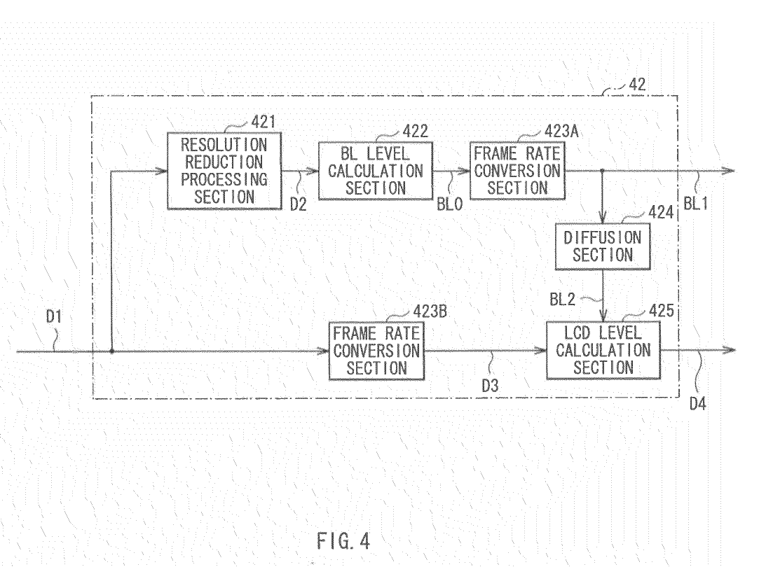

The partitioning-drive processing section 42 is for performing a predetermined partitioning-drive process with respect to the video signal D1 coming from the video signal processing section 41. With such a predetermined partitioning-drive process, a emission-pattern signal BL1 and a partitioning-drive video signal D4 are to be generated. The emission-pattern signal BL1 indicates a pattern of light emission of each of the emission sub-regions 36 in the backlight 3. To be specific, the partitioning-drive processing section 42 generates the emission-pattern signal BL1 and the partitioning-drive video signal D4 while performing a predetermined high frame rate conversion process that will be described later. This predetermined high frame rate conversion process includes processing of speed conversion and frame interpolation), and is performed based on the video signal D1. The detailed configuration of such a partitioning-drive processing section 42 will be described later (FIGS. 4 to 6).

The timing control section 43 is for controlling the timing for driving the backlight drive section 50, the gate driver 52, and the data driver 51, and is also for supplying, to the data driver 51, the partitioning-drive video signal D4 coming from the partitioning-drive processing section 42.

The gate driver 52 is for line-sequentially driving the pixels 20 in the liquid crystal display panel 2 along their corresponding gate lines G described above. This line-sequential driving is performed in accordance with the timing control by the timing control section 43. On the other hand, the data driver 51 is for supplying a video voltage based on the partitioning-drive video signal D4 to each of the pixels 20 in the liquid crystal display panel 2. The video voltage is the one provided by the timing control section 43. To be specific, for a supply of video voltage as such, the data driver 51 generates an analog video signal, i.e., the video voltage described above, by performing D/A (Digital/Analog) conversion to the partitioning-drive video signal D4, and outputs the resulting video voltage to each of the pixels 20. As such, the pixels 20 in the liquid crystal display panel 2 are driven for display based on the partitioning-drive video signal D4.

The backlight drive section 50 is for driving, for light emission (for illumination), the emission sub-regions 36 in the backlight 3 under the timing control by the timing control section 43. For such driving, the backlight drive section 50 uses, as a basis, the emission-pattern signal BL1 coming from the partitioning-drive processing section 42.

### Detailed Configuration of Partitioning-drive Processing Section 42

By referring to FIGS. 4 to 6, described next is the detailed configuration of the partitioning-drive processing section 42. FIG. 4 is a block diagram showing the configuration of the partitioning-drive processing section 42. This partitioning-drive processing section 42 is configured to include a resolution reduction processing section 421, a BL level calculation section 422 (a light emission pattern generation section), frame rate conversion sections (a speed conversion section and a frame interpolation section) 423A, i.e., a first frame rate conversion section, 423B, i.e., a second frame rate conversion section, a diffusion section 424, and an LCD level calculation section 425, i.e., a first video signal generation section.

The resolution reduction processing section 421 is for generating a video signal D2 (a resolution reduction signal) by performing a predetermined resolution reduction process to the video signal D1. This video signal D2 is used as a basis of the emission-pattern signal BL1 described above. To be specific, the resolution reduction processing section 421 generates the video signal D2 by reconstructing the video signal D1 being a luminance level signal (a pixel signal) for each of the pixels 20 to a luminance level signal for each of the emission sub-regions 36 where the resolution is lower than that of the pixels 20. For signal reconstruction as such, the resolution reduction processing section 421 extracts any predetermined amount of characteristics from a plurality of pixel signals in the emission sub-regions 36. The amount of characteristics herein includes the maximum or average luminance level, the luminance level of combination thereof, or others.

The BL level calculation section 422 is for generating a emission-pattern signal BL0 (a primary emission-pattern signal), which indicates a pattern of light emission on the basis of each of the emission sub-regions 36. For signal generation as such, the BL level calculation section 422 calculates the luminance level of light emission in each of the emission sub-regions 36 based on the video signal D2, which is a luminance level signal for each of the emission sub-regions 36. To be specific, the BL level calculation section 422 analyzes the luminance level of the video signal D2 for each of the emission sub-regions 36, thereby obtaining the pattern of light emission responsive to the luminance level in each of the regions.

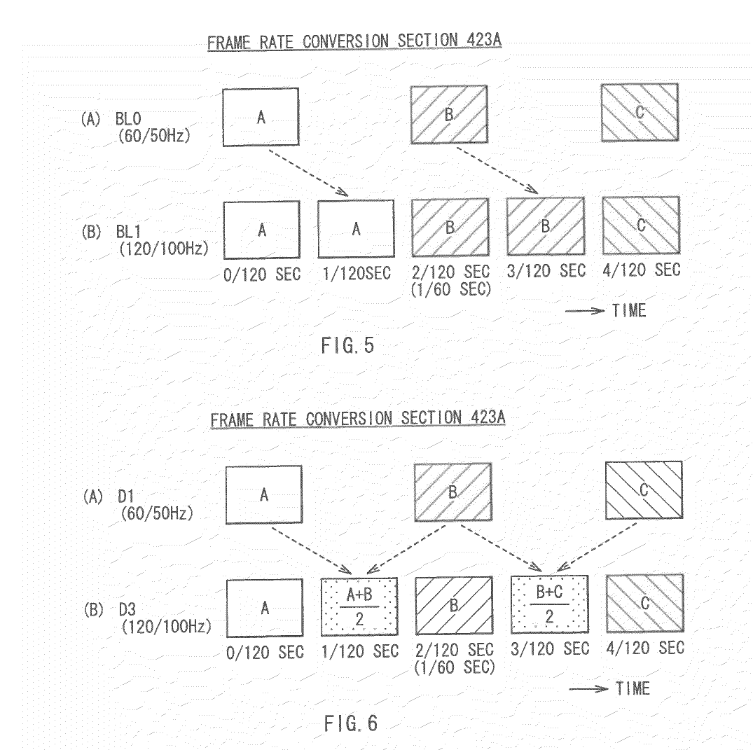

The frame rate conversion section 423A is for performing a high frame rate conversion process, i.e., a first frame-rate-increasing conversion, with respect to the emission-pattern signal BL0 generated by the BL level calculation section 422. The signal generated by the high frame rate conversion process as such is a emission-pattern signal, i.e., the emission-pattern signal BL1 described above. To be specific, the frame rate conversion section 423A generates the emission-pattern signal BL1 by a high frame rate conversion process in which an original frame of the emission-pattern signal BL0 is inserted. In other words, as shown in A and B of FIG. 5, for example, the frame interpolation uses as they are the original frames “A”, “B”, “C”, and others of the emission-pattern signal BL0 (e.g., with the frame frequency of 60 Hz or 50 Hz). Such a frame interpolation in this example generates a emission-pattern signal BL1 (with the frames of “A”, “A”, “B”, “B”, “C”, “C”, and others) with the frame frequency twice higher than that of the emission-pattern signal BL0, e.g., 120 Hz or 100 Hz. Note here that, unlike the frame rate conversion section 423B that performs a high frame rate conversion process with motion compensated frame interpolation (will be described later), the reason for the frame rate conversion section 423A to perform the high frame rate conversion process with frame interpolation as such is as below. That is, considering the expected performance, for the emission-pattern signal BL1 on the side of the backlight 3, the reduction of circuit size often comes first than the improvement of image quality during moving image display unlike with the partitioning-drive video signal D4 on the side of the liquid crystal display panel 2.

The frame rate conversion section 423B is for performing another high frame rate conversion process, i.e., a second frame-rate-increasing conversion, with respect to the video signal D1, and generates a video signal D3 as a result of the high frame rate conversion process as such. To be specific, the frame rate conversion section 423B generates the video signal D3 by motion compensated frame interpolation, i.e., by a high frame rate conversion process with motion compensated frame interpolation. In other words, as shown in A and B of FIG. 6, for example, using motion vectors in picture videos in the original frames “A”, “B”, and “C” of the video signal D1 (e.g., with the frame frequency of 60 Hz or 50 Hz), the frame rate conversion section 423B generates by interpolation a picture video between each two of the original frames next to each other. To be specific, in this example, generated are interpolation frames shown in B of FIG. 6, i.e., “(A+B)/2”, “(B+C)/2”, and others. The motion compensated frame interpolation as such generates a video signal D3 (with the frames of “A”, “(A+B)/2”, “B”, “(B+C)/2”, “C”, and others) with the frame frequency twice higher than that of the video signal D1, e.g., 120 Hz or 100 Hz. Note here that B of FIG. 6 shows the picture videos denoted by “(A+B)/2”, “(B+C)/2” as those generated by interpolation as above. These picture videos are the representation for convenience, and are not representing the actual calculation equation.

The diffusion section 424 is for performing a predetermined diffusion process with respect to the emission-pattern signal BL1 coming from the frame rate conversion section 423A, and then for providing the resulting emission-pattern signal BL2 after the diffusion process to the LCD level calculation section 425. The diffusion section 424 performs signal conversion from the signal on the basis of the emission sub-region 36 to the signal on the basis of the pixel 20. Such a diffusion process is performed considering the luminance distribution in the actual light source (the LEDs emitting lights of various colors) in the backlight 3, i.e., considering the diffusion distribution of light coming from the light source.

The LCD level calculation section 425 is for generating a partitioning-drive video signal D4 based on the video signal D3 coming from the frame rate conversion section 423B, and the emission-pattern signal BL2 as a result of the diffusion process. To be specific, the LCD level calculation section 425 generates the partitioning-drive video signal D4 by dividing the signal level of the video signal D3 by the emission-pattern signal BL2 as a result of the diffusion process. More in detail, the LCD level calculation section 425 uses the following equation (1) to generate the video signal D4.

D4=(D3/BL2) (1)

Herein, the above equation (1) leads to the relationship of Original Signal (Video Signal D3)=(Emission-pattern signal BL2×Partitioning-drive video signal D4). In this relationship, the expression of (Emission-pattern signal BL2×Partitioning-drive video signal D4) has the physical meaning of overlaying an image of the partitioning-drive video signal D4 on images of the emission sub-regions 36 in the backlight 3 illuminating in a specific pattern of light emission. Although the details will be described later, such image overlay offsets the light distribution on the liquid crystal display panel 2, and leads to viewing equivalent to view the original display, i.e., display with the original signal.

### Effects and Advantages of Liquid Crystal Display Device 1

Next, described are the effects and advantages of the liquid crystal display device 1 in this embodiment.

### 1. General Outline of Partitioning-Light-Emission Operation

In this liquid crystal display device 1, as shown in FIG. 1, first of all, the video signal processing section 41 performs predetermined image processing with respect to an input video signal Din, thereby generating a video signal D1. Next, the partitioning-drive processing section 42 performs a predetermined partitioning-drive process with respect to this video signal D1. With such processing, generated are a emission-pattern signal BL1 and a partitioning-drive video signal D4. The emission-pattern signal BL1 indicates a pattern of light emission on the basis of each of the emission sub-regions 36 in the backlight 3.

The partitioning-drive video signal D4 and the emission-pattern signal BL1 generated as such are then input to the timing control section 43. Herein, the partitioning-drive video signal D4 is provided by the timing control section 43 to the data driver 51. The data driver 51 performs D/A conversion to this partitioning-drive video signal D4, thereby generating a video voltage being an analog signal. Thereafter, in response to a drive voltage coming from the gate driver 52 and the data driver 51 to each of the pixels 20, a display driving operation is performed. As such, the pixels 20 in the liquid crystal display panel 2 are driven for display based on the partitioning-drive video signal D4.

To be specific, as shown in FIG. 2, a selection signal provided by the gate driver 52 over the gate line G is used as a basis to turn ON or OFF the TFT element 21. Such switching selectively brings the components into conduction, i.e., the date line D, the liquid crystal element 22, and the auxiliary capacity element 23. As a result, a video voltage based on the partitioning-drive video signal D4 coming from the data driver 51 is provided to the liquid crystal element 22 so that the display drive operation is performed line-sequentially.

On the other hand, the emission-pattern signal BL1 is provided by the timing control section 43 to the backlight drive section 50. The backlight drive section 50 uses this emission-pattern signal BL1 as a basis to drive the emission sub-regions 36 in the backlight 3 for light emission, i.e., to perform a partitioning-drive operation.

At this time, for any of the pixels 20 provided with the video voltage, an illumination light coming from the backlight 3 is modulated in the liquid crystal display panel 2, and the resulting light is emitted as a display light. As such, video display based on the input video signal Din is performed in the liquid crystal display device 1.

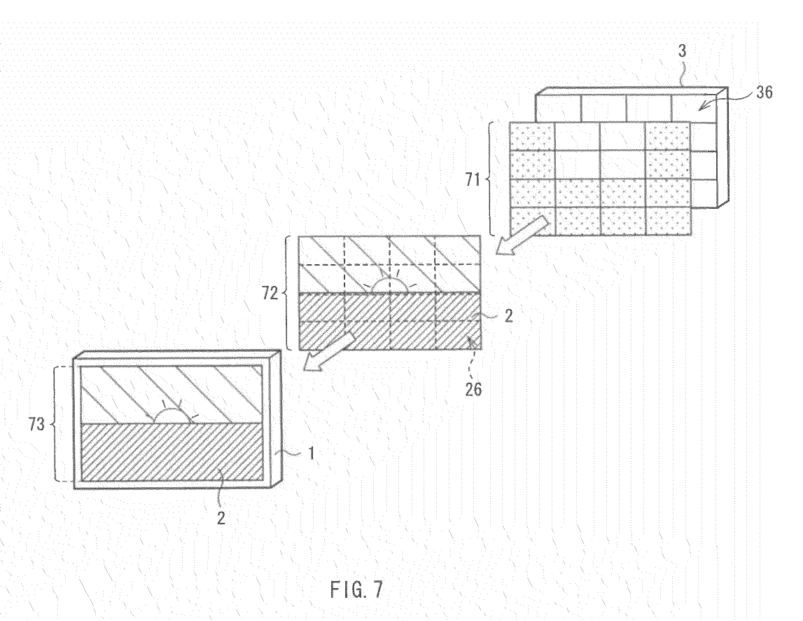

To be specific, as shown in FIG. 7, for example, the liquid crystal display device 1 displays in its entirety a synthetic image 73 for eventual viewing. This synthetic image 73 is the result of physical overlay (synthesis like multiplying) of a panel surface image 72 on a light emission surface image 71. The light emission surface image 71 is the image of the emission sub-regions 36 in the backlight 3, and the panel surface image 72 is the image of only the display panel 2.

### 2. Partitioning-Light-Emission Operation Suitable for Video Display Utilizing High Frame Rate Conversion Process

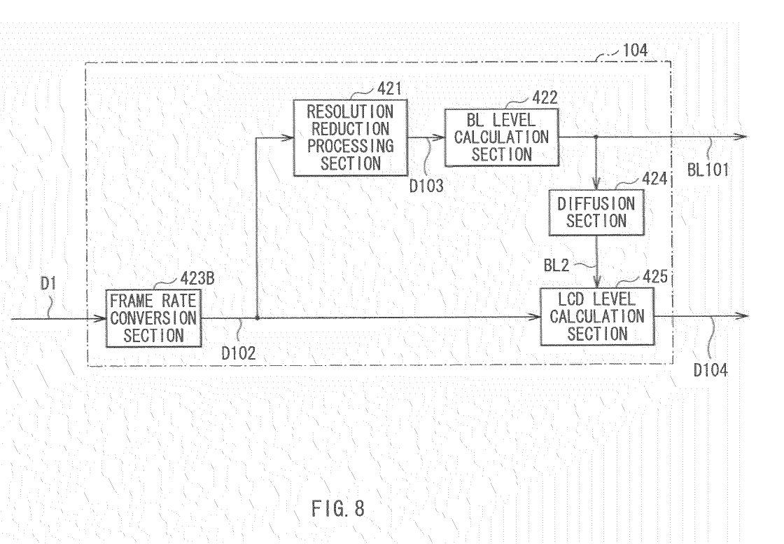

Next, by referring to FIGS. 8 to 12, described in detail is one of the characteristics of the invention, i.e., a partitioning-light-emission operation suitable for video display utilizing a high frame rate conversion process by way of comparison with comparison examples (comparison examples 1 and 2).

### 2-1. Comparison Example 1

FIG. 8 is a block diagram showing the configuration of a partitioning-drive processing section in a liquid crystal display device in a comparison example 1, i.e., a partitioning-drive processing section 104. Compared with the partitioning-drive processing section 42 in the embodiment of FIG. 4, this partitioning-drive processing section 104 in this comparison example 1 leaves out (is not provided with) the frame rate conversion section 423A, and the frame rate conversion section 423B therein is changed in position. To be specific, the frame rate conversion section 423B in this example is disposed at the frontmost stage in the partitioning-drive processing section 104.

In such a partitioning-drive processing section 104, first of all, the frame rate conversion section 423B performs a high frame rate conversion process with motion compensated frame interpolation with respect to the video signal D1, thereby generating a video signal D102 as a result of the high frame rate conversion process as such. Next, the resolution reduction processing section 421 performs a resolution reduction process with respect to this video signal D102, thereby generating a video signal D103. Thereafter, based on this video signal D103, the BL level calculation section 422 generates a emission-pattern signal BL101 that indicates a pattern of light emission on the basis of each of the emission sub-regions 36. Moreover, the diffusion section 424 performs a diffusion process with respect to the emission-pattern signal BL101 coming from the BL level calculation section 422, and outputs the resulting emission-pattern signal BL102 after the diffusion process to the LCD level calculation section 425. The LCD level calculation section 425 then generates a partitioning-drive video signal D104 based on the video signal D102 after the high frame rate conversion process as described above and the emission-pattern signal BL102 after the diffusion process. To be specific, the LCD level calculation section 425 uses the following equation (2) similarly to the embodiment, thereby generating the video signal D104.

D104=(D102/BL102) (2)

In the partitioning-drive processing section 104 in this comparison example 1, the video signal D102 is through with the high frame rate conversion process performed by the frame rate conversion section 423B before input to the side of the resolution reduction processing section 421 and the BL level calculation section 422. Therefore, this video signal D102 has the frame rate (e.g., the frame frequency of 120 Hz or 100 Hz) higher than that of the original video signal, i.e., the video signal D1. This thus causes an increase of processing load for processing later on using the video signal D102 as such. To be specific, there needs to increase the clock frequency, to perform two-phase/four-phase processing, or others for the resolution reduction process or for the process of calculating the emission-pattern signal BL101. As a result, the processing load becomes too much for the resolution reduction processing section 421 and for the BL level calculation section 422. This results in a size increase of circuit in the portion of such components or others, and eventually results in a cost increase.

Such problems greatly hinder the possibility of integration of the components on a chip, i.e., the block subsequent to the frame rate conversion section 423B, for example. Moreover, another problem as below occurs when a product line-up is to be expanded based on the provision of the function of partitioning-light-emission operation. In this case, such a two-chip structure is a possibility that a first LSI (Large Scale Integration) includes the resolution reduction processing section 421, and the BL level calculation section 422, and a second LSI includes the frame rate conversion section 423B, the diffusion section 424, and the LCD level calculation section 425. In an alternative two-chip structure, a first LSI may include the resolution reduction processing section 421, the BL level calculation section 422, and the diffusion section 424, and a second LSI may include the frame rate conversion section 423B, and the LCD level calculation section 425. With both of such two-chip structures, however, the first LSI is large in circuit size, and the resulting LSI is thus expensive.

### 2-2. Comparison Example 2

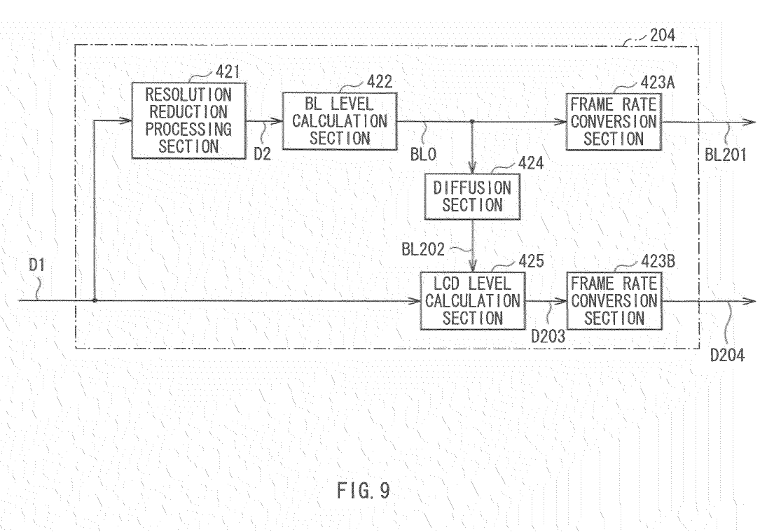

On the other hand, FIG. 9 is a block diagram showing the configuration of a partitioning-drive processing section in a liquid crystal display device in a comparison example 2, i.e., a partitioning-drive processing section 204. Compared with the partitioning-drive processing section 42 in the embodiment of FIG. 4, in this partitioning-drive processing section 204 in this comparison example 2, the frame rate conversion sections 423A and 423B are both changed in position. To be specific, the frame rate conversion sections 423A and 423B in this example are both disposed at the rearmost stage in the partitioning-drive processing section 204.

In such a partitioning-drive processing section 204, first of all, the resolution reduction section 421 performs a resolution reduction process with respect to a video signal D1 similarly to the embodiment, thereby generating a video signal D2. Next, based on this video signal D2, the BL level calculation section 422 generates a emission-pattern signal BL0, i.e., a primary emission-pattern signal, also similarly to the embodiment. Thereafter, the frame rate conversion section 423A performs a high frame rate conversion process with frame interpolation with respect to this emission-pattern signal BL0, thereby generating a emission-pattern signal BL201. The diffusion section 424 performs a diffusion process with respect to the emission-pattern signal BL0, and outputs the resulting emission-pattern signal BL202 after the diffusion process to the LCD level calculation section 425. On the other hand, the LCD level calculation section 425 generates a video signal D203 based on the video signal D1 and the emission-pattern signal BL202 as a result of the diffusion process. To be specific, the LCD level calculation section 425 uses the following equation (3) similarly to the embodiment, thereby generating the video signal D203. Thereafter, the frame rate conversion section 423B performs a high frame rate conversion process with motion compensated frame interpolation with respect to the video signal D203 generated as such, thereby generating a partitioning-drive video signal D204.

D203=(D1/BL202) (3)

In the partitioning-drive processing section 204 in this comparison example 2, a video signal D102 is not yet through with a high frame rate conversion process before input to the side of the resolution reduction processing section 421 and the BL level calculation section 422. This video signal D102 thus has a low frame rate (e.g., the frame frequency of 60 Hz or 50 Hz). Therefore, unlike in the comparison example 1 described above, there is no need to increase the clock frequency or to perform two-phase/four-phase processing for the resolution reduction process or for the process of calculating the emission-pattern signal BL0. This thus causes no increase of circuit size unlike in the comparison example 1.

However, this comparison example 2 causes a degradation problem of the display image quality as will be described below. This degradation of display image quality is due to the misalignment between interpolation frames generated by the high frame rate conversion process with the emission-pattern signal BL201 and the partitioning-drive video signal D204.

Exemplified now is a case where the video signal D1 for input to the partitioning-drive processing section 204 represents the image of a small bright object moving slowly from the left to right side in the screen. This object is displayed against a background being dark in its entirety, i.e., gray level.

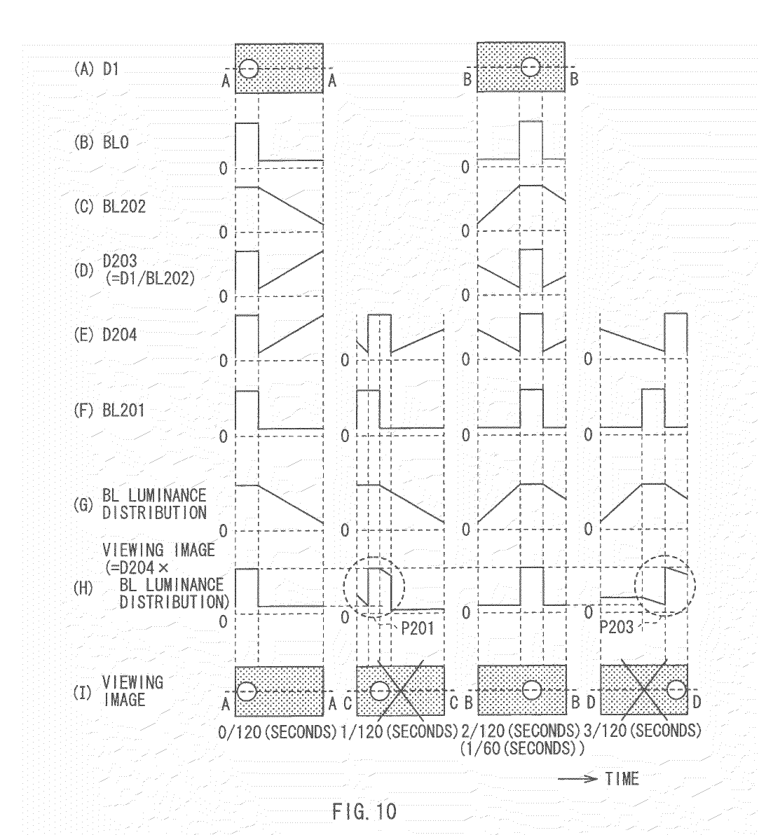

FIG. 10 is a timing chart schematically showing the partitioning-light-emission operation in such a case in the liquid crystal display device in the comparison example 2. In FIG. 10, A denotes a video signal D1, B denotes a emission-pattern signal BL0, C denotes a emission-pattern signal BL202, D denotes a video signal D203 (=D1/BL202), E denotes a partitioning-drive video signal D204, and F denotes a emission-pattern signal BL201. Also in FIG. 10, G denotes the actual luminance distribution in the backlight 3, i.e., BL luminance distribution, and H and I each denote an image (=D204×BL luminance distribution) to be actually viewed. Herein, in B to H, the lateral axis indicates the pixel positions in the horizontal direction along a line A-A or B-B in A and I, or along a line C-C or D-D in I. Moreover, in A and I, the longitudinal axis indicates the pixel positions in the longitudinal direction (vertical direction) of the screen, and in B to H, the longitudinal axis indicates the level axis.

In this comparison example 2, as described above, the frame rate conversion section 423A performs the high frame rate conversion process with frame interpolation with respect to the emission-pattern signal BL0, thereby generating the emission-pattern signal BL201 (refer to B and F in FIG. 10). Accordingly, as shown in F in FIG. 10, a frame of 1/120 (seconds), i.e., an interpolation frame, and a frame of 0/120 (second), i.e., an original frame, share the same pattern of light emission. Similarly, a frame of 3/120 (seconds), i.e., an interpolation frame, and a frame of 2/120 (seconds), i.e., an original frame, share the same pattern of light emission.

On the other hand, the frame rate conversion section 423B performs the high frame rate conversion process with motion compensated frame interpolation with respect to the video signal D203, thereby generating the partitioning-drive video signal D204 (refer to D and E in FIG. 10). Accordingly, as shown in E in FIG. 10, for example, the position of the object in the picture video of a frame of 1/120 (seconds), i.e., an interpolation frame, is at the midpoint between the positions thereof in the picture videos of frames of 0/120 and 2/120 (seconds) preceding and subsequent thereto, i.e., original frames. Similarly, the position of the object in the picture video of a frame of 3/120 (seconds), i.e., an interpolation frame, is at the midpoint between the positions thereof in the picture videos of frames of 2/120 and 4/120 (seconds) preceding and subsequent thereto, i.e., original frames. In other words, with the partitioning-drive video signal D204, unlike with the emission-pattern signal BL201 described above, the video pictures in the original frames look different from those in the interpolation frames.

As is known from equation (3) above and FIG. 9, the partitioning-drive video signal D204 is the one generated by the high frame rate conversion process different from that performed to generate the emission-pattern signal BL201. In other words, the frame rate conversion section 423B on the side of the liquid crystal display panel 2 performs the high frame rate conversion process separately from the frame rate conversion section 423A on the side of the backlight 3. Therefore, with the partitioning-light-emission operation in this comparison example 2, the degradation problem of display image quality occurs as will be described later due to the misalignment (inappropriate position combination) between the interpolation frames with the emission-pattern signal BL201 and the partitioning-drive video signal D204. In other words, in this example, as indicated by reference numerals P201 and P203 in H in FIG. 10 and by large crosses placed in some of the frames in I in FIG. 10, the object and the background in the viewing image partially fail to reach the originally expected luminance level, i.e., their luminance level is lower or higher than the original luminance level. As a result, the viewing image is with gradations, i.e., with variations of luminance levels.

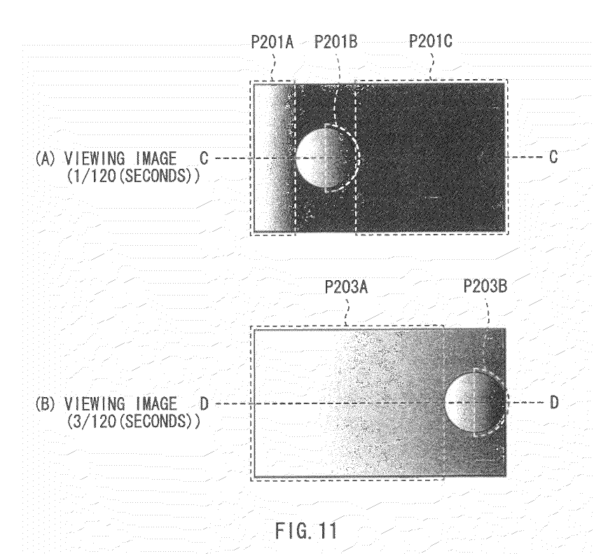

To be specific, with the viewing image ( 1/120 (seconds)) of FIG. 11A, the pixel region indicated by a reference numeral P201A has the luminance level higher (brighter) than the originally expected luminance level, and the pixel regions respectively indicated by reference numerals P201B and P201C have the luminance level lower (darker) than the originally expected luminance level. On the other hand, with the viewing image ( 3/120 (seconds)) of FIG. 11B, the pixel regions respectively indicated by reference numerals P203A and P203B both have the luminance level lower (darker) than the originally expected luminance level. Note here that the center portion of the gradations in the pixel regions of P201B and P203A in FIGS. 11A and 11B is, to be precise, the center of the luminance distribution of the backlight 3 with the emission-pattern signal BL201 of G in FIG. 10. Moreover, although the pixel region of P201C in FIG. 11A seems to be constant in luminance level in H in FIG. 10, the luminance level therein does not always remain the same.

### 2-3. Partitioning-Light-Emission Operation in Embodiment

On the other hand, in the embodiment, the eventual emission-pattern signal BL1 is generated by the partitioning-drive processing section 42 generating a emission-pattern signal BL0 based on a video signal D1, and then by performing a high frame rate conversion process with respect to the emission-pattern signal BL0. Moreover, the partitioning-drive video signal D4 in this embodiment is generated based on the emission-pattern signal BL1 described above and a video signal D3, which is the result of a high frame rate conversion process with motion compensated frame interpolation performed with respect to the video signal D1. As such, the partitioning-light-emission operation in this embodiment does not cause the increase of circuit size unlike in the comparison example 1 described above, and reduce or prevent (prevent in the following example) the degradation of the display image quality unlike in the comparison example 2 described above. In the below, such a partitioning-light-emission operation in the embodiment is described in detail.

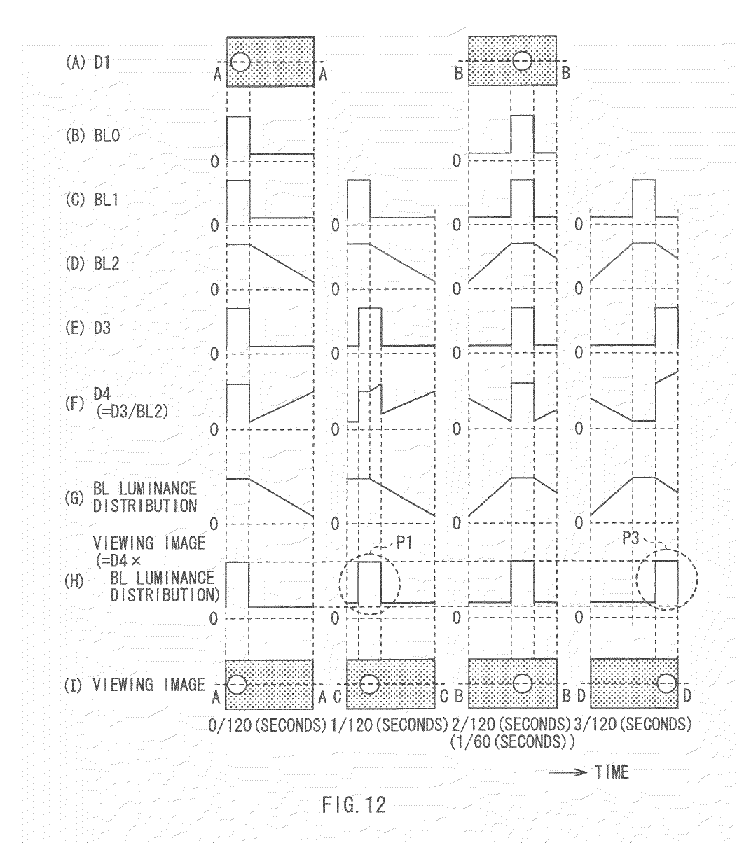

Exemplified now is a case, similarly to FIG. 10, where the video signal D1 for input represents the image of a small bright object moving slowly from the left to right side in the screen. This object is displayed against a background being dark in its entirety. FIG. 12 is a timing chart schematically showing the partitioning-light-emission operation in such a case in the liquid crystal display device 1 in the embodiment. In FIG. 12, A denotes a video signal D1, B denotes a emission-pattern signal BL0, C denotes a emission-pattern signal BL1, D denotes a emission-pattern signal BL2, E denotes a video signal D3, and F denotes a partitioning-drive video signal D4 (=D3/BL2). Also in FIG. 12, G denotes the actual luminance distribution in the backlight 3, i.e., BL luminance distribution, and H and I each denote an image (=D4×BL luminance distribution) to be actually viewed. Herein, in B to H, the lateral axis indicates the pixel positions in the horizontal direction along a line A-A or B-B in A and I, or along a line C-C or D-D in I. Moreover, in A and I, the longitudinal axis indicates the pixel positions in the longitudinal direction (vertical direction) of the screen, and in B to H, the longitudinal axis indicates the level axis.

In this embodiment, first of all, the frame rate conversion section 423A performs the high frame rate conversion process with frame interpolation with respect to the emission-pattern signal BL0, thereby generating the emission-pattern signal BL1 (refer to B and C in FIG. 12). Accordingly, similarly to the comparison example 2 described above, as exemplarily shown in C in FIG. 12, a frame of 1/120 (seconds), i.e., an interpolation frame, and a frame of 0/120 (second), i.e., an original frame, share the same pattern of light emission. Similarly, a frame of 3/120 (seconds), i.e., an interpolation frame, and a frame of 2/120 (seconds), i.e., an original frame, share the same pattern of light emission.

On the other hand, the frame rate conversion section 423B in the embodiment performs the high frame rate conversion process with motion compensated frame interpolation with respect to the video signal D1, thereby generating the video signal D3 (refer to A and E in FIG. 12). Accordingly, as shown in E in FIG. 12, for example, the position of the object in the picture video of a frame of 1/120 (seconds), i.e., an interpolation frame, is at the midpoint between the positions thereof in the picture videos of frames of 0/120 and 2/120 (seconds) preceding and subsequent thereto, i.e., original frames. Similarly, the position of the object in the picture video of a frame of 3/120 (seconds), i.e., an interpolation frame, is at the midpoint between the positions thereof in the picture videos of frames of 2/120 and 4/120 (seconds) preceding and subsequent thereto, i.e., original frames. In other words, with the video signal D3, unlike with the emission-pattern signal BL1 described above, the video pictures in the original frames look different from those in the interpolation frames. This is similar to the comparison example 2 described above with the partitioning-drive video signal D204 and the emission-pattern signal BL201.

However, in this embodiment, unlike the comparison example 2, the video signal D1 is subjected to the high frame rate conversion process with motion compensated frame interpolation. Then based on the resulting video signal after this high frame rate conversion process, i.e., the video signal D3, and the emission-pattern signal BL1, the partitioning-drive video signal D4 is generated. To be specific, in the LCD level calculation section 425, the partitioning-drive video signal D4 is generated based on the emission-pattern signal as a result of the high frame rate conversion process, i.e., the emission-pattern signal BL1, and the video signal also as a result of the high frame rate conversion process, i.e., the video signal D3 (refer to F in FIG. 12).

Therefore, with the partitioning-light-emission operation in the embodiment, unlike with that in comparison example 2, the problem of misalignment (inappropriate position combination) does not occur between the interpolation frames with the emission-pattern signal BL1 and the partitioning-drive video signal D4. To be specific, in this example, as indicated by reference numerals P1 and P3 in H in FIG. 12, the object and the background in the viewing image favorably achieve the originally expected luminance level, and the viewing image is not with gradations, i.e., not with variations of luminance levels. In other words, the partitioning-light-emission operation in this embodiment successfully reduces or prevents the degradation of the image quality that is caused by the misalignment between the interpolation frames with the emission-pattern signal and the partitioning-drive video signal.

Moreover, in the partitioning-drive processing section 42 in this embodiment, the video signal D2 is not yet through with a high frame rate conversion process before input to the side of the resolution reduction processing section 421 and the BL level calculation section 422. This video signal D2 thus has a low frame rate (e.g., the frame frequency of 60 Hz or 50 Hz). In other words, the partitioning-drive processing section 42 first generates the emission-pattern signal BL0 based on the video signal D1, and then generates the emission-pattern signal BL1 by performing the high frame rate conversion process with respect to the emission-pattern signal BL0.

Accordingly, similarly to the comparison example 2 described above, for the resolution reduction process or for the process of calculating the emission-pattern signal BL0, there is no need to increase the clock frequency or to perform two-phase/four-phase processing. In other words, compared with the above comparison example 1 of generating a emission-pattern signal in a reverse order, i.e., generating a emission-pattern signal based on a signal as a result of a high frame rate conversion process performed to the video signal D1, the partitioning-drive processing section can be reduced in size in its entirety, i.e., there is no increase of circuit size unlike in the comparison example 1.

As such, in the embodiment, after generating the emission-pattern signal BL0 based on a video signal D1, the partitioning-drive processing section 42 generates the emission-pattern signal BL1 by performing a high frame rate conversion process with respect to the emission-pattern signal BL0. The partitioning-drive processing section 42 also generates the partitioning-drive video signal D4 based on the emission-pattern signal BL1 and a video signal (the video signal D3) as a result of the high frame rate conversion process with motion compensated frame interpolation performed with respect to the video signal D1. This accordingly reduces the size of the partitioning-drive processing section 42 in its entirety, reduces the appearance of afterimages during display of moving images with motion compensated frame interpolation, and reduces or prevents the degradation of the image quality in interpolation frames. As such, for video display using a light source section in charge of the partitioning-light-emission operation, the display image quality can be favorably increased with a reduction of cost. What is more, performing the partitioning-light-emission operation successfully leads to a reduction of power consumption and an improvement of black luminance similarly with the previous partitioning-light-emission operation.

### Modified Examples

Described next are modified examples (modified examples 1 and 2) of the embodiment described above. Note that any component similar to that in the embodiment is provided with the same reference numeral, and is not described twice if appropriate.

### Modified Example 1

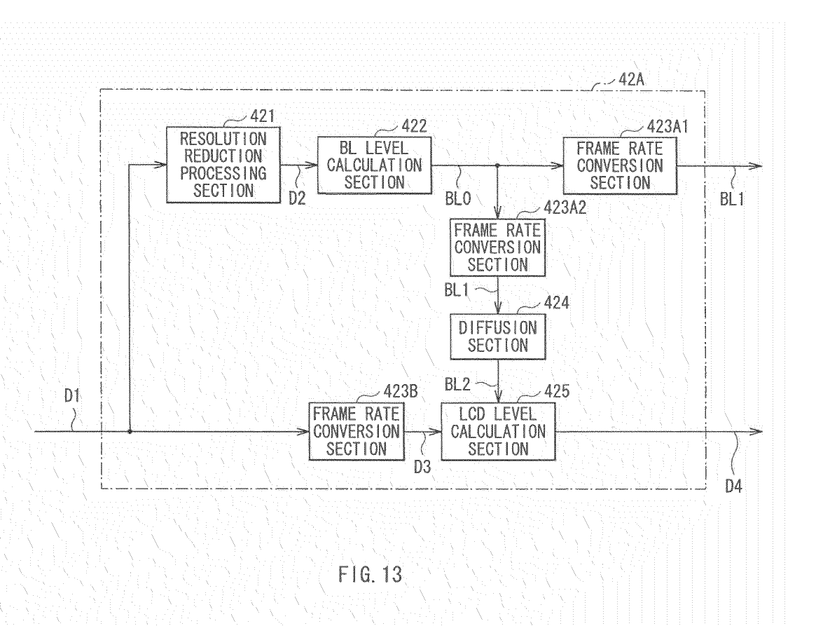

FIG. 13 is a block diagram showing the configuration of a partitioning-drive processing section in a liquid crystal display device in a modified example 1, i.e., a partitioning-drive processing section 42A. Compared with the partitioning-drive processing section 42 of FIG. 4, the partitioning-drive processing section 42A in this modified example includes the frame rate conversion section 423A different in configuration. To be specific, the partitioning-drive processing section 42A is configured to include two frame rate conversion sections 423A1 (a first high frame rate conversion section) and 423A2, which are both perform a high frame rate conversion process with frame interpolation. These frame rate conversion sections 423A1 and 423A2 are provided in the state subsequent to the BL level calculation section 422.

In this example, the LCD level calculation section 425 in the partitioning-drive processing section 42A is a specific example of a “second video signal generation section” of the invention, and the frame rate conversion section 423A2 and the diffusion section 424 are a specific example of a “signal processing section” of the invention.

In the partitioning-drive processing section 42A in this modified example, similarly to the frame rate conversion section 423A in the above embodiment, the frame rate conversion section 423A1 performs a high frame rate conversion process with frame interpolation with respect to a emission-pattern signal BL0, thereby generating a emission-pattern signal BL1. The frame rate conversion section 423A2 also performs the high frame rate conversion process with frame interpolation with respect to the emission-pattern signal BL0, thereby generating the emission-pattern signal BL1. Next, the diffusion section 424 performs a diffusion process with respect to the emission-pattern signal BL1 coming from the frame rate conversion section 423A2, thereby generating a emission-pattern signal BL2. The LCD level calculation section then generates a partitioning-drive video signal D4 based on the emission-pattern signal BL2 and a video signal as a result of a high frame rate conversion process performed by a frame rate conversion section 423B, i.e., a video signal D3.

Also in the liquid crystal display device using the partitioning-drive processing section 42A configured as such, the effects similar to those in the above embodiment can be favorably achieved.

Further, in this modified example, the two-chip structure is a possibility, e.g., an LSI on the side of the backlight 3 may include the resolution reduction processing section 421, the BL level calculation section 422, and the frame rate conversion section 423A1, and another LSI on the side of the liquid crystal display panel 2 may include the frame rate conversion sections 423A2 and 423B, the diffusion section 424, and the LCD level calculation section 425. If this is the configuration, such advantages as below may be achieved. That is, such two LSIs may be provided in the stage where signals (a video signal D1 and a emission-pattern signal BL0) are low in frame rate as are not yet through with a high frame rate conversion process. This structure thus favorably leads to a size reduction of the LSI on the side of the backlight 3, and an easy interface between the LSI on the side of the backlight 3 and the LSI on the side of the liquid crystal display panel 2, thereby achieving low-cost development.

Still further, in this modified example, the emission-pattern signal BL0 is subjected to a high frame rate conversion process by the frame rate conversion section 423A2, and to a diffusion process by the diffusion section 424 in this order. Accordingly, unlike the following modified example 2 of performing such two processes in the reverse order, the circuit size can be reduced more. In other words, such effects can be achieved better than the modified example 2 considering that the emission-pattern signal BL1 before the diffusion process has a lower resolution than that after the diffusion process.

### Modified Example 2

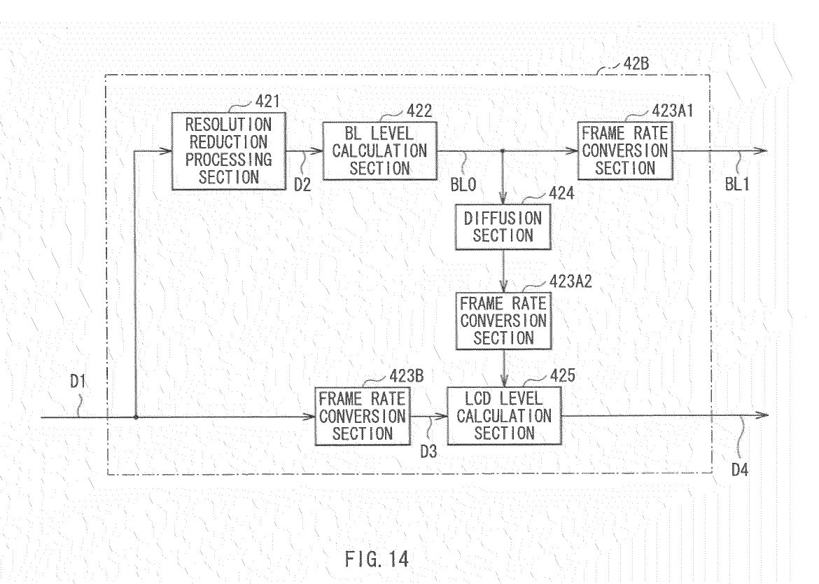

FIG. 14 is a block diagram showing the configuration of a partitioning-drive processing section in a liquid crystal display device in a modified example 2, i.e., a partitioning-drive processing section 42B. Compared with the partitioning-drive processing section 42A in the modified example 1 shown in FIG. 13, the partitioning-drive processing section 42B in this modified example includes the frame rate conversion section 423A2 and the diffusion section 424, which are opposite in position. In other words, in this partitioning-drive processing section 42B, the diffusion section 424 and the frame rate conversion section 423A2 are disposed in this order between the BL level calculation section 422 and the LCD level calculation section 425.

In this example, the LCD level calculation section 425 in the partitioning-drive processing section 42B is a specific example of a “second video signal generation section” of the invention, and the diffusion section 424 and the frame rate conversion section 423A2 are a specific example of a “signal processing section” of the invention.

Also in the liquid crystal display device using the partitioning-drive processing section 42B configured as such, the effects similar to those in the above embodiment can be favorably achieved.

Moreover, also in this modified example, the two-chip structure of an LSI on the side of the backlight 3 and another LSI on the side of the liquid crystal display panel 2 may lead to the effects similar to those in the modified example 1 described above.

### Other Modified Examples

While the invention has been described in detail, the foregoing description is in all aspects illustrative and not restrictive. It is understood that numerous other modifications and variations can be devised.

Exemplified in the above embodiment and others is the case that the frame rate conversion sections 423, 423A1, and 423A2 each perform the high frame rate conversion process with frame interpolation, but this is surely not restrictive. In other words, in some cases, the frame rate conversion sections 423, 423A1, and 423A2 may perform the high frame rate conversion process with motion compensated frame interpolation as does the frame rate conversion section 423B.

Further, in the above embodiment and others, exemplified is the case that the backlight is configured to include a red LED, a green LED, and a blue LED for use as a light source. Such a configuration is surely not the only possibility, and in addition thereto (or as alternatives thereto), the backlight may include a light source emitting a light of any other colors. When the backlight is configured to emit lights of four or more colors, for example, the color reproducibility is accordingly enhanced so that a wide variety of colors may be represented thereby.

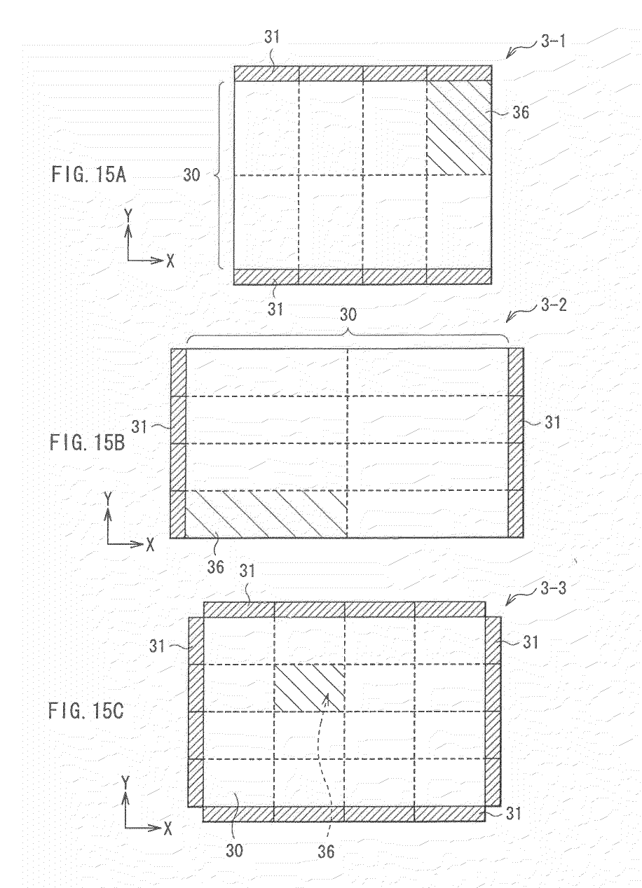

Still further, in the above embodiment and others, exemplified is the case that the backlight 3 is a so-called direct-lit backlight (a light source section). This is surely not restrictive, and the invention is applicable to a so-called edge-lit backlight like backlights 3-1 to 3-3 of FIGS. 15A to 15C, for example. To be specific, these backlights 3-1 to 3-3 are each configured to include a light guide plate 30, and a plurality of light sources 31. The light guide plate 30 is in the rectangular shape, and serves as a plane from which lights are emitted. The light sources 31 are disposed on the side surfaces of the light guide plate 30, i.e., on the side surfaces of the plane from which lights are emitted. More in detail, with the backlight 3-1 of FIG. 15A, a plurality of (four in this example) light sources 31 are disposed on both of a pair of opposing side surfaces of the rectangular light guide plate 30, i.e., on both side surfaces in the vertical direction. With the backlight 3-2 of FIG. 15B, a plurality of (four in this example) light sources 31 are disposed on both of a pair of opposing side surfaces of the rectangular light guide plate 30, i.e., on both side surfaces in the horizontal direction. With the backlight 3-3 of FIG. 15C, a plurality of (four in this example) light sources 31 are disposed on all of two pairs of opposing side surfaces of the rectangular light guide plate 30, i.e., on the side surfaces both in the vertical and horizontal directions. With such configurations, the backlights 3-1 to 3-3 each include a plurality of individually-controllable emission sub-regions 36 on the planes of the light guide plate 30 from which lights are emitted.

In addition thereto, the process procedure in the above embodiment and others may be performed by hardware or by software. When the process procedure is performed by software, a program configuring the software is installed into a general-purpose computer, for example. Such a program may be recorded in advance in a recording medium provided in the computer.

The present application contains subject matter related to that disclosed in Japanese Priority Patent Application JP 2010-090454 filed in the Japan Patent Office on Apr. 9, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
a light source section including a plurality of emission subsections which are controlled separately from one another;
a liquid crystal display panel performing image-display through modulating, based on an input image signal, light coming from each of the emission subsections in the light source section; and
a display control section having a partitioning-drive processing section which generates an emission-pattern signal and a partitioning-drive image signal based on the input image signal, the emission-pattern signal representing a two-dimensional pattern formed from lighting emission subsections in the light source section, the display control section performing light-emission drive on each of the emission subsections in the light source section based on the emission-pattern signal, and performing display-drive on the liquid crystal display panel based on the partitioning-drive image signal,
wherein the partitioning-drive processing section performs processes of:
generating, based on the input image signal, a primary emission-pattern signal corresponding to a primary pattern formed from the lighting emission subsections;
executing a first frame-rate-increasing conversion on the primary emission-pattern signal, thereby to create the emission-pattern signal;
executing a second frame-rate-increasing conversion on the input image signal by a method of frame interpolation with motion compensation; and
generating the partitioning-drive image signal, based on both the created emission-pattern signal and the resultant image signal of the second frame-rate-increasing conversion.

2. The liquid crystal display device according to claim 1, wherein
the first frame-rate-increasing conversion is executed by a frame interpolation method in which an original image frame of the primary emission-pattern signal is inserted between the very image frame and a subsequent image frame of the primary emission-pattern signal.

3. The liquid crystal display device according to claim 1, wherein
the partitioning-drive processing section generates the primary emission-pattern signal, based on a lowered-resolution image signal which is created through lowering a resolution of the input image signal, and
the partitioning-drive processing section generates the partitioning-drive image signal, based on both a diffused emission-pattern signal and the resultant image signal of the second frame-rate-increasing conversion, the diffused emission-pattern signal being created through performing a predetermined diffusion process on the emission-pattern signal.

4. The liquid crystal display device according to claim 1, wherein
the partitioning-drive processing section generates the primary emission-pattern signal, based on a lowered-resolution image signal which is created through lowering a resolution of the input image signal, and
the partitioning-drive processing section generates the partitioning-drive image signal, based on both a processed primary emission-pattern signal and the resultant image signal of the second frame-rate-increasing conversion, the processed primary emission-pattern signal being created through performing a predetermined diffusion process on the primary emission-pattern signal.

5. The liquid crystal display device according to claim 1, wherein
the light source section is configured of a light source of direct-lighting type or edge-lighting type.
